(19) United States
(12) Patent Application Publication
(10) Pub. No.: US 2003/0215187 A1
(43) Pub. Date: Nov. 20, 2003

(54) Waveguide to V-groove arrangement

(75) Inventors: Jolyon Richard Tidmarsh, Oxford (GB); Matthew Peter Shaw, Oxford (GB); John Paul Drake, Berkshire (GB)

Correspondence Address: LAHIVE & COCKFIELD, 28 STATE STREET, BOSTON, MA, 02109, US

(73) Assignee: Bookham Technology plc, Oxfordshire (GB)

(21) Appl. No.: 10/371,611

(22) Filed: Feb. 20, 2003

(30) Foreign Application Priority Data
Feb. 20, 2002 (GB) 0203943.6

(51) Int. Cl. G02B 6/30; G02B 6/12

(52) U.S. Cl. 385/49; 385/14

(57) ABSTRACT

An arrangement of an integrated optical waveguide (1) relative to a V-groove (2) for receiving an optical fibre (5) which is to be optically coupled with an end of the waveguide (1) is described. A waveguide (1) is formed in a crystalline optical substrate (3), and a V-groove (2) formed therein beneath an elongate parallel sided window in the substrate with a centre line (2A) of the V-groove (2) aligned with an end (1A) of the waveguide (1). The parallel sides (2B, 2C) of the window at the end of the V-groove (2) aligned with the waveguide (1) terminate out of alignment with each other in a direction along the length of the V-groove whereby the V-groove undercuts a portion (3A) of the optically conducting layer (3) beneath said end of the waveguide (1). The end of the waveguide (1) therefore overhangs the end of the V-groove (2) to enable the end of an optical fibre (5) to be located in close proximity thereto.

This invention relates to an arrangement of an integrated optical waveguide relative to a V-groove for receiving an optical fibre which is to be optically coupled with an end of the waveguide and to a method of fabricating such an arrangement.

U.S. Pat. No. 5,787,214 describes an optical coupling between an integrated optical waveguide formed in a silicon layer with an optical fibre located in a V-groove. The end of the waveguide overhangs the end of the V-groove in the form of a diving board so as to enable the end face of the optical fibre to be located in closer proximity with the end face of the waveguide. This arrangement is necessary because the etch used to fabricate the V-groove follows crystallographic planes in the silicon which results in the formation of an inclined end face in the V-groove which prevents the end of the fibre being located in close proximity to the waveguide facet. The diving board thus overhangs this inclined end face to bring the end of the waveguide into closer proximity with the end of the optical fibre. The disclosure of U.S. Pat. No. 5,787,214 is hereby incorporated within this specification.

Whilst this known arrangement has proved successful, the present invention aims to improve the arrangement further.

According to a first aspect of the invention, there is provided an arrangement of an integrated optical waveguide relative to a V-groove for receiving an optical fibre which is to be optically coupled with an end of the waveguide, the arrangement comprising a waveguide formed in a crystalline optical substrate, and a V-groove being formed beneath an elongate parallel sided window in the substrate with a centre line of the V-groove aligned with an end of the waveguide, the parallel sides of the window terminating at the end of the V-groove aligned with the waveguide out of alignment with each other in a direction along the length of the V-groove whereby the V-groove undercuts a portion of the optically conducting layer beneath said end of the waveguide.

According to a second aspect of the invention, there is provided an arrangement of an integrated optical waveguide relative to a V-groove for receiving an optical fibre which is to be optically coupled with one end of the waveguide, the waveguide being formed in an optical substrate a portion of which extends over an end of the V-groove, said portion being integral with part of the substrate on one side of the V-groove but spaced from the substrate on the other side of the V-groove.

According to another aspect of the invention, there is provided a method of fabricating an arrangement as detailed above comprising the steps of:

fabricating an integrated optical waveguide in an optical substrate;

forming an elongate, parallel sided window in the optical substrate with one end aligned with an end of said waveguide, the parallel sides of the window at the end aligned with the waveguide terminating out of alignment with each other in a direction along the length of said window; and

etching a V-groove through said window so as to undercut an end portion of said waveguide.

Preferred and optional features of the invention will be apparent from the following description and from the subsidiary claims of the specification.

The invention will now be further described, merely by way of example, with reference to the accompanying drawings, in which:

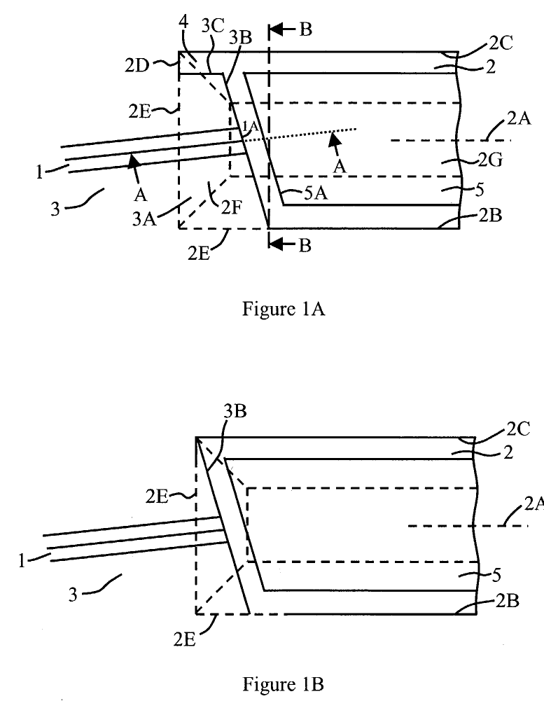

FIG. 1A is a schematic plan view of a preferred form of an arrangement according to the invention and FIG. 1B is a similar view of another embodiment of the arrangement;

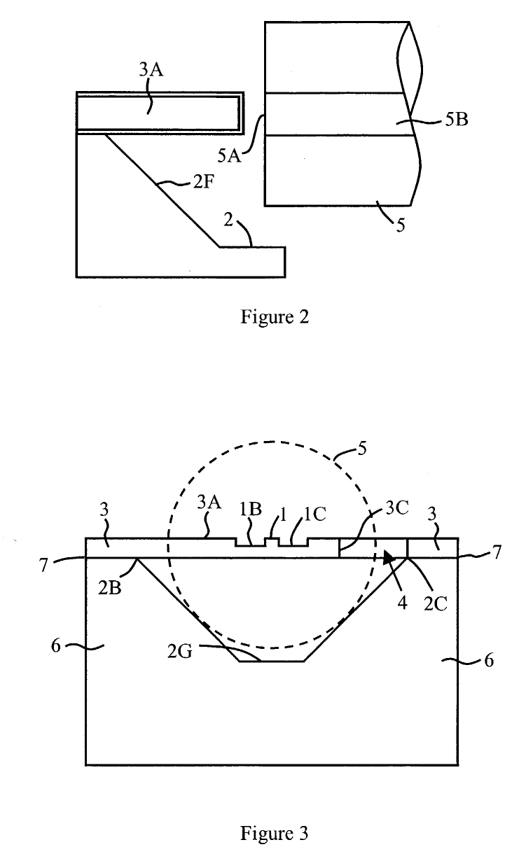

FIG. 2 is a cross-sectional view taken on line A-A of FIG. 1A;

FIG. 3 is a cross-sectional view taken on line B-B of FIG. 1A, and

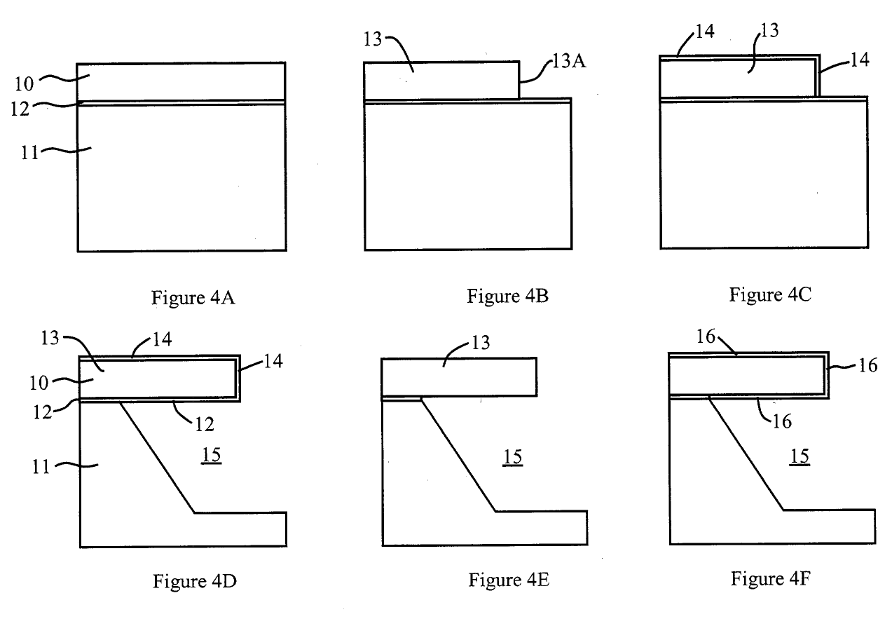

FIGS. 4A to 4F illustrate steps in a method of fabricating an arrangement such as that shown in FIG. 2.

FIG. 1A shows a plan view of an integrated optical waveguide 1 the end face 1A of which is (approximately) aligned with a centre line 2A of a V-groove 2. The waveguide 1 is formed in an optically conductive layer 3, e.g. of silicon, and a portion 3A of this layer extends over an end of the V-groove 2 at least to some extent (the extent of the V-groove 2 beneath said portion 3A being indicated by dashed lines 2E).

FIG. 2 is a cross-sectional view taken on line A-A of FIG. 1 along the optical axis of the waveguide 1 and shows the portion 3A overhanging an inclined end face 2F of the V-groove 2.

The portion 3A is arranged so that it is integrally formed with adjacent areas of the optically conductive layer 3 on one side of the V-groove (the side defined by line 2B) but spaced from adjacent areas of the optically conductive layer 3 on the other side of the V-groove (the side defined by line 2C). Such an arrangement significantly increases the physical strength of the portion 3A compared to the diving board of the arrangement described in U.S. Pat. No. 5,787,214. The optically conducting layer 3 extends away from the end of the waveguide 1 on both sides thereof so the portion 3A is of substantial width as shown in FIG. 3. In the arrangement show, the portion 3A has a width of at least 75% and preferably 85% or more of the width of the V-groove (measured as the perpendicular distance between lines 2B and 2C). In a typical arrangement, the portion 3B thus has a width of at least 100 microns and preferably at least 120 microns. Furthermore, the connection of one side of the portion 3A to adjacent areas of the layer 3 significantly increases the strength of the overhanging portion 3A.

The diving board described in U.S. Pat. No. 5,787,214 is vulnerable to impact, e.g. when the fibre is located in the V-groove, which can cause it to fracture. Furthermore, as it is only connected at one end, it is liable to flexing, especially in applications where it might be subject to shock loads or high g-forces.

FIG. 1A shows an arrangement in which a substantially rectangular gap 4 is provided at one side of the portion 3A, one end of this gap being defined by a line 2D extending perpendicular to the line 2C at the end of the V-groove 2. The line 2D assists in determining the position of the end of the V-groove 2 and hence how far the V-groove undercuts the portion 3A.

The V-groove 2 is formed by etching through a window defined by the lines 2B, 2C and 2D and shaped at the end to form the overhang bonded by lines 3B and 3C. Lines 2B and 2C are preferably substantially straight and substantially parallel. However, it should be noted that a parallel-sided V-groove can be formed through a parallel-sided etch window even if the sides of the window are not straight, e.g. if they are slightly wavy.

FIG. 1A shows an optical fibre 5 located in the V-groove 2, the optical axis of the fibre 5 being parallel to the centre line 2A of the V-groove 2.

An end face 3B of the portion 3A is substantially co-planar with the end face 1A of the waveguide 1 and is preferably inclined, e.g. by around 3 degrees, to the perpendicular to the optical axis of waveguide 1 to reduce back reflections at this interface.

Light emerging from the end face 1A undergoes refraction by several degrees due to the angle of the end face 1A so the optical axis of the waveguide is inclined to the optical axis of the fibre 5, typically by about 4 degrees. The end face 5A of the optical fibre is also preferably inclined by around 7 degrees to the perpendicular to the optical axis of the fibre to reduce back reflection at this interface. The end face 5A of the fibre 5 preferably lies substantially parallel to the end face 1 A of the waveguide 1.

To achieve a low loss optical coupling between the waveguide 1 and fibre 5 the spacing between end faces 1A and 5A is preferably less than 20 microns and most preferably around 10 microns or less. If desired, an index matching compound may be provided between the end faces 1A and 5A. A gap of around 10 microns between end faces 1A and 5A is preferred so as to provide a thermal expansion gap to accommodate expansion of the fibre 5 with variations in temperature. Due to the refraction at faces 1A and 5A and the gap therebetween, there may be a small lateral offset, e.g. of around 0.5 microns, between the centre line 2A and the optical axis of the waveguide 1 at the end face 1A of the waveguide.

In a typical arrangement, the V-groove 2 has a width (between lines 2B and 2C) of about 140 microns and the portion 3A overhangs the end of the V-groove 2 by a distance of around 60 microns, the gap 4 having a width (perpendicular to the length of the V-groove 2) of about 20 microns.

The portion 3B preferably overhangs at least 50% of the length of the inclined end face 2F measured in a direction along the length of the V-groove as shown in FIG. 1A and preferably over at least 75% of the length of the inclined end face. In some embodiments, the portion 3B overhangs the entire length of the inclined end face 2F, particularly in devices, such as that shown, in which the V-groove is not etched to its full depth but is only etched to a depth sufficient to accommodate the fibre so it is left with a flat base 2G as shown (see FIG. 3). The portion 3B need only overhang so far as to permit the end face 5A of the fibre to be positioned in close proximity with the end face 1A of the waveguide, e.g. within 20 microns or less as mentioned above. The length of the gap 4 (in a direction parallel to the length of the V-groove) may, for instance, be 20-60 microns or greater.

Preferably a curved fillet (not shown) is provided in the corner between the line 2D and side face 3C of the portion 3A to strengthen this area.

FIG. 1B shows a similar arrangement to that shown in FIG. 1A but without the substantially rectangular gap 4. As above, the V-groove is etched to an extent determined by the length of the longer side 2C of the window formed through the silicon layer 3 as shown by the dashed lines and undercuts a portion 3A of the silicon layer 3. The extent of the overhang is, in this case, determined by the angle the end face 3B of the portion 3A makes with the sides 2B and 2C of the V-groove. Depending on the material from which the optically conductive layer 3 is formed and the orientation of the end face 5A of the fibre, this may be sufficient in some cases. However, if a greater degree of undercut is required, an arrangement such as that shown in FIG. 1A is preferred.

The location of the fibre 5 along the V-groove 2 may be determined by stops (not shown) projecting from the sides of the V-groove as described in U.S. Pat. No. 5,787,214. However, if the overhanging portion 3A in the arrangements described above is made sufficiently strong to withstand a fibre being butted up against it, such stops are not required.

FIG. 3 shows a cross-sectional view taken along line B-B of FIG. 1A with the optical fibre 5 shown in dashed lines for clarity.

FIG. 3 shows that the waveguide 1 comprises a rib defined between trenches 1B and 1C etched on either side thereof in the silicon layer 3.

The arrangement is preferably fabricated in a silicon substrate and most preferably in a silicon-on-insulator (SOI) substrate comprising an optically conductive layer 3 of silicon separated from a supporting substrate 6 (which may also be of silicon) by an optical confinement layer 7, e.g. of silicon dioxide.

As shown in FIG. 3, the layer 3 preferably extends away from the waveguide beyond the trenches 1B and 1C to increase the strength of the overhang 3A further.

FIGS. 4A-4F illustrate steps in the fabrication of an arrangement such as that shown in FIG. 2.

FIG. 4A shows the initial substrate, in this case a silicon-on-insulator chip comprising an optically conductive layer of silicon 10 separated from a supporting substrate 11, typically also of silicon, by an optical confinement layer 12, e.g. of silicon dioxide. In electrical applications, the silicon dioxide provides an electrically insulating layer, hence the name silicon-on-insulator.

An etch is first carried out to define a rib waveguide 13 (between trenches 1B and 1C as shown in FIG. 3) in the silicon layer 10 to form the arrangement shown in FIG. 4B. This etch preferably also defines the end face 13A of the waveguide. Preferably the location of the V-groove is also defined by the same etch, i.e. the positions of lines 2B, 2C and 2D shown in FIG. 1. The V-groove and waveguide are thus automatically aligned with each other as their locations are defined by the same etch step(s).

A protective layer 14 of silicon dioxide is then formed over the waveguide 13 to protect it from damage during the following etch steps as shown in FIG. 4C.

The V-groove 15 is then etched, e.g. by an anisotropic etch such as KOH or CsOH, which undercuts the end of the waveguide 13 as shown in FIG. 4D, the underside of the waveguide 13 being protected by the layer 12 of silicon dioxide.

The protective layer 14 of silicon dioxide and the layer 12 of silicon dioxide beneath the overhanging portion are then removed as shown in FIG. 4E and replaced by a layer 16 of silicon nitride as shown in FIG. 4F, e.g. by liquid phase chemical vapour deposition (LPCVD). The layer 16 of silicon nitride provides an anti-reflective coating on the end face 13A of the waveguide. The layer of silicon nitride over the other surfaces of the waveguide 13 acts as an optical confinement layer as the refractive index of silicon nitride is lower than that of silicon.

The removal of the oxide layer and deposition of a layer of nitride in its place also helps reduce birefringence in the waveguide 1 which helps reduce polarisation dependent losses as described in GB2357342A.

In an alternative arrangement, the waveguide may be left as shown in FIG. 4E, i.e. without an optical confinement layer 12 beneath the overhanging portion of the waveguide 13 (or the optical confinement layer 12 beneath the waveguide 13 may be removed but a coating retained over the upper surfaces and/or end surface of the waveguide). The optical confinement layer 12 beneath the waveguide 13 can be dispensed with as the interface between the waveguide 13 and material beneath the overhang, which would typically be air, confines the light so long as said material has a lower refractive index, e.g. of 2.5 or less, than the material from which the waveguide 13 is formed (a silicon waveguide having a refractive index of about 3.5).

FIG. 1 schematically illustrates rib waveguide 1 as a simple rib waveguide. However, a tapered structure may be provide at the end thereof, e.g. as described in U.S. Pat. No. 6,108,478. Such a tapered structure enlarges the end face 1A of the waveguide so as to provide better mode matching with the core 5B of the optical fibre 5.

Furthermore, as part of this tapering structure, the width of the rib of the waveguide may be increased towards the end of the overhang 3A and the overhang 3 may be further strengthened by reducing the widths of the trenches 1B and 1C) towards the end thereof. This, together with the provision of a tapered structure formed on the rib as described in U.S. Pat. No. 6,108,478 further increases the strength of the overhang 3A as it increases the cross-sectional area thereof.

A T-bar (not shown) is preferably provided at the end of the waveguide, e.g. as described in U.S. Pat. No. 6,266,468. Again, this helps in strengthening the overhang 3A.

As described above, the integrated waveguide is preferably a rib waveguide formed in a silicon substrate such as a silicon-on-insulator chip. However, it will be appreciated that other types of waveguide may be used. Other materials may also be used in place of silicon, the arrangement described being applicable to other substrates in which etches used to form V-grooves follow crystallographic planes resulting in an inclined end face at the end of the V-groove.

Another significant advantage of the method of fabrication described above is that the end face 1A of the waveguide may be defined by a vertical etch, e.g. when the waveguide is being defined (as in FIG. 4B), so there is no need to polish the end face to ensure it is sufficiently flat.

1. An arrangement of an integrated optical waveguide relative to a V-groove for receiving an optical fibre which is to be optically coupled with an end of the waveguide, the arrangement comprising a waveguide formed in a crystalline optical substrate, and a V-groove being formed beneath an elongate parallel sided window in the substrate with a centre line of the V-groove aligned with an end of the waveguide, the parallel sides of the window terminating at the end of the V-groove aligned with the waveguide out of alignment with each other in a direction along the length of the V-groove whereby the V-groove undercuts a portion of the optically conducting layer beneath said end of the waveguide.

2. An arrangement as claimed in claim 1 in which said portion has a side face which is spaced from said other side of the V-groove.

3. An arrangement as claimed in claim 1 in which said portion extends across at least 75% and preferably at least 85% of the width of the V-groove.

4. An arrangement as claimed in claim 1 in which said portion extends in a direction across the width of the V-groove by a distance of at least 100 microns and preferably at least 125 microns.

5. An arrangement as claimed in claim 1 in which the V-groove has an inclined end face and said portion overhangs at least 50% and preferably at least 75% of the length of the inclined end face measured in a direction along the length of the V-groove.

6. An arrangement as claimed in claim 1 in which the optical substrate is silicon.

7. An arrangement as claimed in claim 1 in which the optical substrate is silicon and comprises an optically conductive layer separated from a supporting substrate by an optical confinement layer.

8. An arrangement as claimed in claim 1 in which the optical substrate is silicon and comprises an optically conductive layer separated from a supporting substrate by an optical confinement layer which is of silicon dioxide.

9. An arrangement as claimed in claim 1 in which an anti-reflective coating is provided on an end face of the waveguide.

10. An arrangement as claimed in claim 1 in which an anti-reflective coating comprising of silicon nitride is provided on an end face of the waveguide.

11. An arrangement as claimed in claim 1 in which an anti-reflective coating is provided on an end face of the waveguide and also extends over upper and/or lower faces of said portion.

12. An arrangement as claimed in claim 1 in which an anti-reflective coating comprising of silicon nitride is provided on an end face of the waveguide and also extends over upper and/or lower faces of said portion.

13. An arrangement as claimed in claim 1 in which the integrated waveguide is a rib waveguide.

14. An arrangement as claimed in claim 1 in which the integrated waveguide is a rib waveguide and in which a tapered structure is provided at the end of the rib waveguide.

15. A method of fabricating an arrangement as claimed in claim 1 comprising the steps of:
fabricating an integrated optical waveguide in an optical substrate;
forming an elongate, parallel sided window in the optical substrate with one end aligned with an end of said waveguide, the parallel sides of the window at the end aligned with the waveguide terminating out of alignment with each other in a direction along the length of said window; and
etching a V-groove through said window so as to undercut an end portion of said waveguide.

16. A method as claimed in claim 15 in which the end portion of said waveguide is protected by an oxide layer during said etching step.

17. A method as claimed in claim 16 in which at least part of the protective oxide layer is removed after the etching steps.

18. A method as claimed in claim 17 in which a nitride layer is provide in place of at least part of the oxide layer which is removed.

19. A method as claimed in claim 15 in which said end of the waveguide is formed by a vertical etch.

20. An arrangement of an integrated optical waveguide relative to a V-groove for receiving an optical fibre which is to be optically coupled with one end of the waveguide, the waveguide being formed in an optical substrate a portion of which extends over an end of the V-groove, said portion being integral with part of the substrate on one side of the V-groove but spaced from the substrate on the other side of the V-groove.

21. A method of fabricating an arrangement as claimed in claim 20 comprising the steps of:
fabricating an integrated optical waveguide in an optical substrate;
forming an elongate, parallel sided window in the optical substrate with one end aligned with an end of said waveguide, the parallel sides of the window at the end aligned with the waveguide terminating out of alignment with each other in a direction along the length of said window; and
etching a V-groove through said window so as to undercut an end portion of said waveguide.
